(19) United States
(12) Patent Application Publication
(10) Pub. No.: US 2009/0309715 A1
(43) Pub. Date: Dec. 17, 2009

(54) Contact-less card reader having associated campaign encrypting/decrypting means and associated campaign processing means

(75) Inventors: Chen Yi Kao, Hsinchu City (TW); Yeh Nai Chia, Hsinchu city (TW)

Correspondence Address: BACON & THOMAS, PLLC, 625 SLATERS LANE, FOURTH FLOOR, ALEXANDRIA, VA, 22314-1176, US

(73) Assignee: Hyweb Technology Co., Ltd., Hsinchu City (TW)

(21) Appl. No.: 12/292,411

(22) Filed: Nov. 19, 2008

(30) Foreign Application Priority Data
Jun. 13, 2008 (TW) 097210481

(51) Int. Cl. G08B 1/08

(52) U.S. Cl. 340/539.11

(57) ABSTRACT

The present invention relates to a contact-less card reader having associated campaign encrypting/decrypting means and associated campaign processing means, in order to process the associated campaign, wherein the associated campaign encrypting/decrypting means are for proceeding security control process of the associated campaign to verify the contact-less card after the card reader reads the data from the contact-less card, the associated campaign processing means are for processing the associated campaign in accordance with the associated campaign rules downloaded from an associated campaign server, the card reader itself executes the transaction authorization process and associated campaign process, and then sends back the result thereof to an electronic data capture so as to execute data recordation in the follows by the electronic data capture and a remote server.

### FIELD OF THE INVENTION

This invention relates to a contact-less card reader having associated campaign encrypting/decrypting means and associated campaign processing means

### BACKGROUND OF THE INVENTION

A contact-less card in the present invention is referred to a card in which a chip of sensor with a coil is embedded so that contact-less communication is achieved in electro-magnetic sensing manner. A user only gets the contact-less card within a sensing area of contact-less card reader to read/write data from/to the card in electro-magnetic communication manner. In general, when EMV transaction, a transaction specification specified by Europay, MaterCard, VISA, is proceeded, it requires EMV applet to be installed in the card. When the associated campaign such as loyalty campaign is proceeded, it requires loyalty applet to be installed in the card.

As compared with the conventional contact card, which requires the card to pass through a slot of the contact card reader, the contact-less card is more convenient, faster, and is safer since it is not necessary to submit the card to cashier. Therefore, the contact-less card is more and more popular.

For being more competitive, the contact-less card is added with extra campaign function such as loyalty campaign. The loyalty campaign is for encouraging customers who consume a specific amount in a specific period by providing discount to the customers. However, the transaction speed for contact-less card is limited by the conventional structure such as shown in FIG. 3 and FIG. 4. Therefore, how to accelerate the transaction speed for the contact-less card with associated campaign becomes a concern.

The loyalty campaign transaction is the same as common transaction in that they both need transaction verification. In transaction verification for loyalty campaign transaction, it needs a key, hereinafter referred to as associated campaign encrypting/decrypting means, for encrypting/decrypting the associated campaign data in order to determine whether the associated campaign transaction such as loyalty campaign transaction is legal or not. However, in conventional structure for contact-less card reader, the associated campaign encrypting/decrypting means and the associated campaign processing means are stored in a associated campaign server or electronic data capture (EDC), as shown in FIG. 3 and FIG. 4, respectively.

In FIG. 3, both associated campaign encrypting/decrypting means 35 and associated campaign processing means are stored in the associated campaign server 34. In Step 3A, the related card information, sum of balance, and transaction verification code stored in the card 31 are read from reader 32 to EDC 33 after EDC initializes a command to do so. In following step 3B1, step 3B2 and step 3B3, the authorization processes of credit card are proceeded. In step 3B1, EDC 33 instructs a reader 32 to proceed a transaction. In step 3B2, it shows an EMV transaction based on EMV transaction means, not shown, embedded in the reader 32. In step 3B3, the EMV transaction result is transmitted to transaction server, not shown, through EDC so as to complete the authorization in the follows. Then, step 3C and step 3D are processing algorithm of the associated campaign transaction, wherein the associated campaign encrypting/decrypting means 35 and associated campaign processing means 36 are stored in the associated campaign server 34. In step 3C, the data received in the associated campaign server 34 in step 3A is processed by the associated campaign encrypting/decrypting means 35 to process the security control of associated campaign, and to process the associated campaign according to the rules regulated by associated campaign processing means 36. The processed data is then sent back to EDC 33. In step 3D, EDC 33 controls reader 32 to execute such as writing process of bonus.

In the above steps, since the associated campaign encrypting/decrypting means 35 and associated campaign processing means 36 are stored in the associated campaign server 34, it requires the connection to the associated campaign server 34, so that the transaction time is rather long, about 11 to 20 seconds. Since the short transaction time required by a contact-less card, such long transaction time causes the transaction failure and software exception. Thus it does not meet the requirement of rapid transaction for a contact-less card.

In FIG. 4, associated campaign encrypting/decrypting means 45 and associated campaign processing means 46 are both stored in EDC 43. Step 4A is different from step 3A in that step 4A not only instructs a reader 42 to read the card information, balance of sum, and transaction proof code from the card 41 to EDC 43, which are processes of transaction authorization, but also the associated campaign encrypting/decrypting means 45 of EDC 43 executes associated campaign security process for verifying the card, and also executes the associated campaign process in accordance with the rules in the associated campaign processing means 46. Step 4B1, step 4B2, step 4B3 are similar with step 3B1, step 3B2, step 3B3 of FIG. 3, which are all processes of authorization for the following authorization, so the explanation is omitted. Next, step 4C is the same as step 3D in FIG. 3, in which EDC 43 controls the reader 42 to execute the writing process of bonus points.

The processes in FIG. 4, as compared with FIG. 3, is advantageous in that the authorization communication time between the EDC 43 and associated campaign server 44 takes less within 4 to 10 seconds, so it is faster than that of FIG. 3. However, since in step 4A, step 4B1, step 4B2, step 4B3, and step 4C, the reader 42 executes authorization of the transaction, and EDC 43 does the associated campaign process, it still costs the data flow between the card reader 42 and the EDC 43. It not only causes the complexity for the process of EDC 43, but also largely increases the communication burden between the EDC 43 and reader 42. The transaction time of 4 to 10 seconds implies the fact that the structure of FIG. 4 still does not meet the requirement needed for a contact-less card.

The present invention is for solving the long transaction time of the conventional contact-less cards.

### SUMMARY OF THE INVENTION

The object of the present invention is to shorten transaction time of EMV transaction that associates with campaign such as loyalty campaign for contact-less card.

The present invention stores associated campaign encrypting/decrypting means 15 and associated campaign processing means 16 in a card reader 12. The associated campaign means 16 periodically downloads associated campaign rules to the card reader 12. In transaction, EDC 13 instructs the card reader 12 to execute the following jobs in the card reader 12 itself, comprising: associated campaign process, transaction authorization process, and writing data to the card 11. After that, the transaction result is then sent back to EDC 13.

The present invention shortens the transaction time of EMV transaction that associates with loyalty campaign to become within 1.5 to 3 seconds. It thus greatly meets the requirement in transaction time for contact-less card.

### BRIEF DESCRIPTION OF THE DRAWINGS

FIG. 1 is a structural view showing contact-less card reader having associated campaign encrypting/decrypting means and associated campaign processing means in the present invention.

FIG. 2 is a structural view showing the downloading of loyalty campaign rules for contact-less reader in the present invention.

FIG. 3 is a structural view showing the conventional contact-less reader.

FIG. 4 is a structural view showing another conventional contact-less reader.

### DETAILED DESCRIPTION OF THE INVENTION

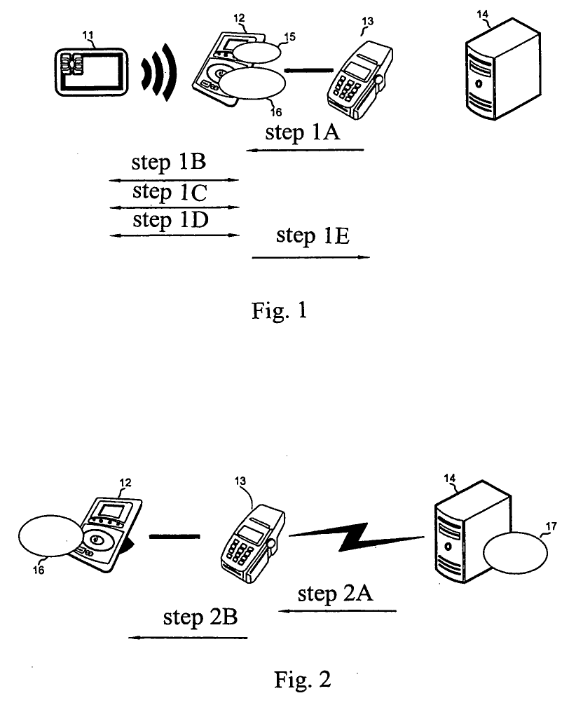

In FIG. 1, the associated campaign encrypting/decrypting means 15 and the associated campaign processing means 16 are both stored in a card reader 12. The EDC 13 periodically downloads the associated campaign rules from the associated campaign server 14 to the associated campaign processing means 16 stored in the reader 12.

In step 1A, the EDC 13 initializes a transaction request to instruct the card reader 12 to execute the following transaction authorization and associated campaign process in the card reader 12. In step 1B, the card reader 12 starts to read the card information such as card number, sum of balance, and transaction proof code. In addition, the card reader 12 directly utilizes the associated campaign encrypting/decrypting means 15 stored in the card reader 12 to execute security control for the associated campaign so as to verify the card being read. The card reader 12 calculates the bonus points for the card 11 in accordance with the associated campaign rules in the associated campaign processing means 16.

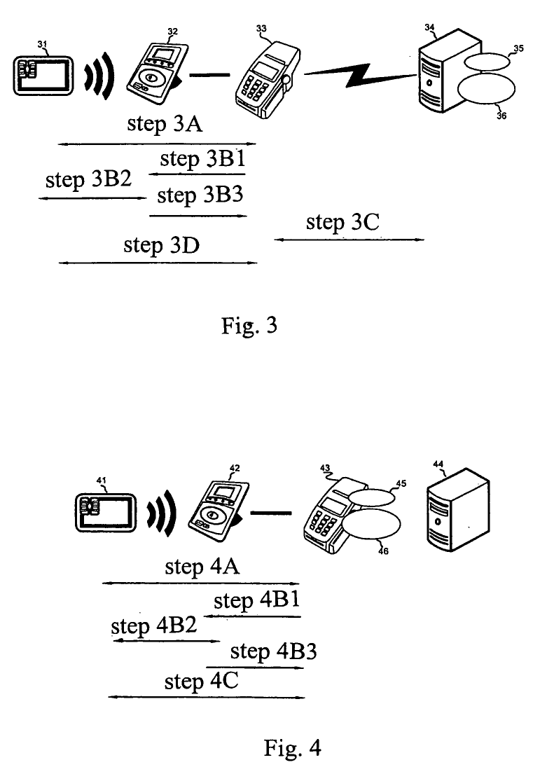

Step 1C is very similar with step 3B2 in FIG. 3 and step 4B2 in FIG. 4, in which they are all steps of transaction authorization being processed between the card reader 12 and the card 11. In the present invention, it does not need EDC 13 to request the card reader 12 to execute EMV transaction. On the contrary, the card reader 12 itself directly processes the authorization process.

Next, step 1D in the present invention is different from that in FIG. 3 in that in the present invention the control of writing bonus to the card 11 is not processed by the EDC 13 but by the card reader 12. In the present invention, it is a reader 12 to directly control the writing bonus to the card 11 according to the calculated result in step 1B.

Lastly, the transaction authorization result and the associated campaign process result are sent back by the card reader 12 to the EDC 13, in step 1E, so as to execute the following recordation between EDC 13 and other servers.

In other words, the card reader 12 in present invention integrally executes transaction process and associated campaign process.

In the present invention, the associated campaign encrypting/decrypting means 15 and associated campaign processing means 16 are stored in the card reader 12 so that the reader itself executes transaction authorization and associated campaign process without the necessity of the coordination in communication between the card reader 12 and EDC 13. The communication time is shortened. In addition, data communication also becomes less complex, so the occurrence of transaction failure and exception reduces.

The associated campaign encrypting/decrypting means 15 in the present invention is achieved by storing keys in a secure access module card (SAM card). The keys are for providing secure control operating functions such as data encryption, data decryption, and the calculation for verification code. The SAM card is plugged in a slot of the card reader 12.

When the card reader 12 is turned on, the card reader 12 executes SAM log-in process via EDC 13 and associated campaign server 14, so as to verify the EDC 13 and SAM card in order to enable the associated campaign encrypting/decrypting means (key) in the SAM card. If the EDC 13 is considered illegal, the associated campaign server 14 will reject the transaction, so that the login of the SAM card will not be complete, and then the associated campaign encrypting/decrypting means will not be enabled, so that the associated campaign verification code, which is needed when writing data to the card, will not be able to be generated. On the contrary, when the SAM card is successfully login, all transactions can be executed until the card reader 12 is turned off. In other words, next time when the card reader 12 is turned on, associated EDC 13 executes the login process for the SAM card.

The calculating algorithm of the loyalty campaign in the present invention is explained as follows as an example.

The rule can be written as follows.

(1) Condition for deducting bonus points: From Jan. 1, 2008 to Dec. 31, 2008, every US$3 can use 10 bonus points to deduct US$0.3 for each transaction.

(2) Condition for adding bonus points: During the above period, every card transaction of US$1 earns 1 bonus point.

In FIG. 2, it shows that the associated campaign rules 17 is periodically downloaded from the associated campaign server 14 to EDC 13, in step 2A, and is downloaded to the card reader 12, in step 2B, so that the associated campaign rules are updated synchronically.

1. A contact-less card reader having associated campaign encrypting/decrypting means and associated campaign processing means, wherein
the associated campaign encrypting/decrypting means are for proceeding security control process of the associated campaign to verify the contact-less card after the card reader reads the data from the contact-less card,
the associated campaign processing means are for processing the associated campaign in accordance with the associated campaign rules downloaded from an associated campaign server,
the card reader itself executes the transaction authorization process and associated campaign process, and then sends back the result thereof to an electronic data capture so as to execute data recordation in the follows by the electronic data capture and a remote server.

2. A contact-less card reader as claimed in claim 1, wherein the data of the contact-less card read by the card reader comprising: card number, sum of balance of the contact-less card, and transaction verification code.

3. A contact-less card reader as claimed in claim 1, wherein the associated campaign process is a bonus points process, and the process is proceeded without the necessity of data communication among the card reader, the electronic data capture, and the associated campaign server.

4. A contact-less card reader as claimed in claim 1, wherein the result of the associated campaign process is written back to the contact-less card.

5. A contact-less card reader as claimed in claim 1, wherein the associated campaign encrypting/decrypting means is a secure access module card, which is plugged in one of the slots of the card reader.

6. A contact-less card reader as claimed in claim 1, wherein the process of transaction authorization and the process of associated campaign are integrated in the card reader.
